(19) United States
(12) Patent Application Publication
(10) Pub. No.: US 2023/0198633 A1
(43) Pub. Date: Jun. 22, 2023

(54) QUANTUM COMMUNICATIONS CAPABILITY FOR EAVESDROP DEFENSE

(71) Applicant: Leidos, Inc., Reston, VA (US)

(72) Inventors: Allyson O’Brien, Arlington, VA (US); Joseph Kovba, Hanover, MD (US)

(73) Assignee: Leidos, Inc., Reston, VA (US)

(21) Appl. No.: 18/068,608

(22) Filed: Dec. 20, 2022

Related U.S. Application Data
(60) Provisional application No. 63/291,709, filed on Dec. 20, 2021.

(51) Int. Cl. H04B 10/70; H04L 9/08

(52) U.S. Cl. CPC H04B 10/70; H04L 9/0852

(57) ABSTRACT

Entangled quantum photons augment a classically encrypted data message and the augmented message, classical decryption key and quantum photon augmentation key are transmitted on a single classical transmission line to a receiver. Eavesdroppers, i.e., attacks, are detected in accordance with changes to the quantum photons in the augmented message.

### CROSS-REFERENCE TO RELATED APPLICATIONS

The present application claims benefit of priority to U.S. Provisional Pat. Application No. 63/291,709, entitled “A QUANTUM COMMUNICATIONS CAPABILITY FOR EAVESDROP DEFENSE,” filed Dec. 20, 2021, the entirety of which is incorporated herein by reference.

### BACKGROUND

### Technical Field

The embodiments are generally directed to eavesdrop detection to secure communications. Specifically, the embodiments leverage quantum systems to combine classical and quantum bits (qubits) in a single data stream, within the same message, allowing for eavesdrop detection based on detection of changes to the state of qubits within the message during transport.

### Desciption of Related Art

The current main focus of quantum communications is to use properties unique to quantum systems to securely transmit sensitive information. The quantum properties that set it apart from classical properties include true randomness, which makes for unbreakable encryption, the inability for adversaries to copy information, and sophisticated eavesdrop detection. It also requires specialized knowledge and equipment to detect and intercept quantum data, making it harder for people to do.

Quantum communications are enabled by a powerful property of quantum systems, called entanglement. Entanglement is the quantum phenomenon that inherently links the states of two particles, caused either by the particles’ proximity to each other, the particles being generated together, or the particles interacting. Once entangled, the particles’ states are dependent upon each other, thus interacting with one will immediately cause a response across the entire entangled system. Experimental validation of maintaining entanglement across long distances has been demonstrated for over 30 years, enabling quantum communications as a field.

Quantum communications, like classical communications, depend on the bit rate of available transmission and reception technology. Early limits on bit rate in quantum communications propelled Quantum key distribution (QKD) into the most widely adopted quantum cryptographic primitive due to the low bit rate required. However, due to the classical exchange and constant shifting implementations, security risks continue to arise. Another drawback to QKD is that it only provides eavesdropped detection on the quantum channel, where the key, and the information to be secure, is transmitted.

With the enabling technology for quantum communications becoming more robust, other types of communication paradigms have been experimentally proven. Quantum secure direct communication (QSDC) is another encryption method with direct, point to point communication that does not need a classical line in the loop. QSDC, however, is not security proved, requires high bit rates and dark fibre, and is very sensitive to noise, which makes it difficult to tell the difference between destructive noise yielding environmentally driven quantum state collapse, and an eavesdropper.

There remain numerous opportunities to merge aspects of quantum communication science with classical communications to improve transmission security.

### SUMMARY OF THE EMBODIMENTS

In a first non-limiting embodiment, a secure communication system includes: an optical transmitter; a single photon emitter; a photonic transmission line; wherein the optical transmitter prepares a classical data bit message and the single photon emitter prepares quantum bits in a predetermined orientation and salts the classical data bit message with the prepared quantum bits in accordance with a predetermined pattern resulting in a quantum augmented classical data bit message which is transmitted over the photonic transmission line.

In a second non-limiting embodiment, a process for securing a classical data bit message, includes: generating a classical data bit message and encrypting the classical data bit message; preparing quantum bits in a predetermined orientation; salting the encrypted classical data bit message with the prepared quantum bits in accordance with a predetermined salting pattern resulting in a quantum augmented classical data bit message; transmitting the quantum augmented classical data bit message over a photonic transmission line; receiving the transmitted quantum augmented classical data bit message at a dual quantum bit and classical bit receiver; and processing the quantum augmented classical data bit message to determine i. if the quantum augmented classical data bit message was intercepted by an eavesdropper during transmission; and ii. decode the quantum augmented classical data bit message to ascertain the message.

### BRIEF SUMMARY OF THE FIGURES

Example embodiments will become more fully understood from the detailed description given herein below and the accompanying drawings, wherein like elements are represented by like reference characters, which are given by way of illustration only and thus are not limitative of the example embodiments herein.

FIG. 1 is a high level system schematic for the single channel, quantum augmented classical bit transmission process (hereafter Quanary) described in one or more embodiments herein;

FIG. 2 is a process schematic showing exemplary quantum augmentation of a classical bit transmission message in accordance with one or more embodiments herein;

FIG. 3 is a process schematic showing exemplary eavesdropping on a quantum augmented classical bit transmission message in accordance with one or more embodiments herein;

FIG. 4 is a process schematic showing exemplary eavesdropping on a quantum augmented, encrypted classical bit transmission message in accordance with one or more embodiments herein;

FIG. 5 is a system and process schematic for detecting an eavesdropper on a transmission line in accordance with one or more embodiments herein;

FIGS. 6a and 6b are schematics of a portion of the system of FIG. 5 for eavesdropping on a transmission line in accordance with one or more embodiments herein;

FIGS. 7a, 7b, 7c, 7d, 7e, 7f are channel data charts from multiple channels and multiple data collection dates showing details which may be used to detect and eavesdropper attack;

FIGS. 8a, 8b, 8c, 8d, 8e, 8f are channel data charts from multiple channels and multiple data collection dates showing details which may be used to detect and eavesdropper attack;

FIG. 9 is a detailed process schematic showing exemplary eavesdropping on a quantum augmented, encrypted classical bit transmission message and detection thereof in accordance with one or more embodiments herein; and

FIG. 10 is a detailed system schematic for detecting eavesdropping on a quantum augmented, encrypted classical bit transmission message in accordance with one or more embodiments herein.

### DETAILED DESCRIPTION

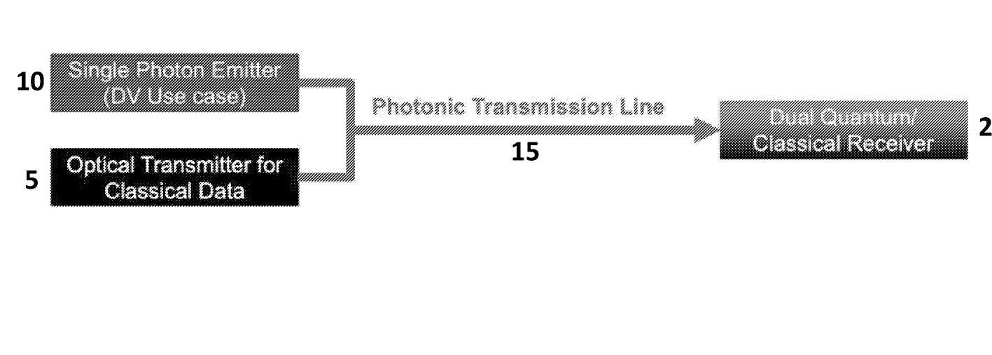

As shown in FIG. 1, the key attributes of the Quanary system include optical transmitter for classical data 5, single photon emitter 10, a single classical transmission line 15 and a dual quantum/classical receiver 20. The process described herein take advantage of quantum photon attributes, such as entanglement, to augment classical data (and encryption) and transmits the augmented classical data message on a single classical transmission line 15.

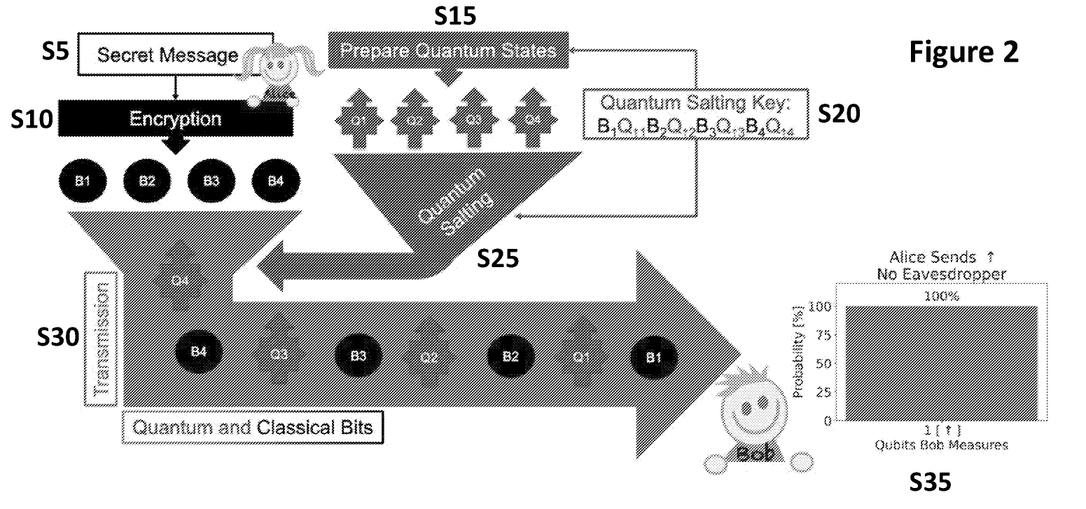

Referring to FIG. 2, a use case embodiment for the system of FIG. 1, the system generates a secret classical bit data message S5 and encrypts the secret classical bit data message S10 using classical methods, e.g., NIST certified algorithm. The encrypted classical data bits are exemplified in FIG. 2 as B1, B2, B3, B4 in this example. Simultaneously, quantum states (qubits) are prepared S15 in set orientation and exemplified in FIG. 2 as Q1, Q2, Q3, Q4 and a quantum salting key is generated S20. The salting key specifies which photons in the communication are quantum bits and which are classical. By way of example, the quantum salting key of this embodiment is: B₁, Q_{↑1}, B₂, Q_{↑2}, B₃, Q_{↑3}, B₄, Q_{↑4}, wherein (↑) indicates set quantum bit orientation. The encrypted classical bit data message is augmented, e.g., salted, with the qubits in accordance with the quantum salting key S25 and the augmented message, as well as the classical encryption key and the quantum salting key, are transmitted across single classical line S30, e.g., a photonic line. Using the transmitted quantum salting key, the receiver is able to ascertain that no eavesdropper disrupted the message S35 by measuring the state of the quantum bits.

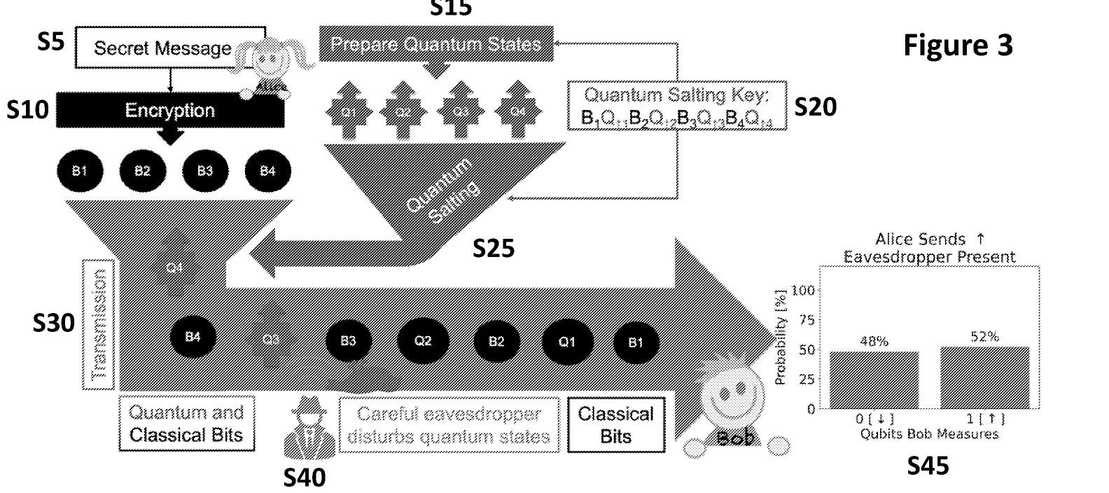

Referring to FIG. 3, in this example, an eavesdropper disturbs the quantum state(s) of a/the qubit(s) in the augmented message during transmission S40. Using the quantum salting key, the receiver is able to ascertain the presence of the eavesdropper S45.

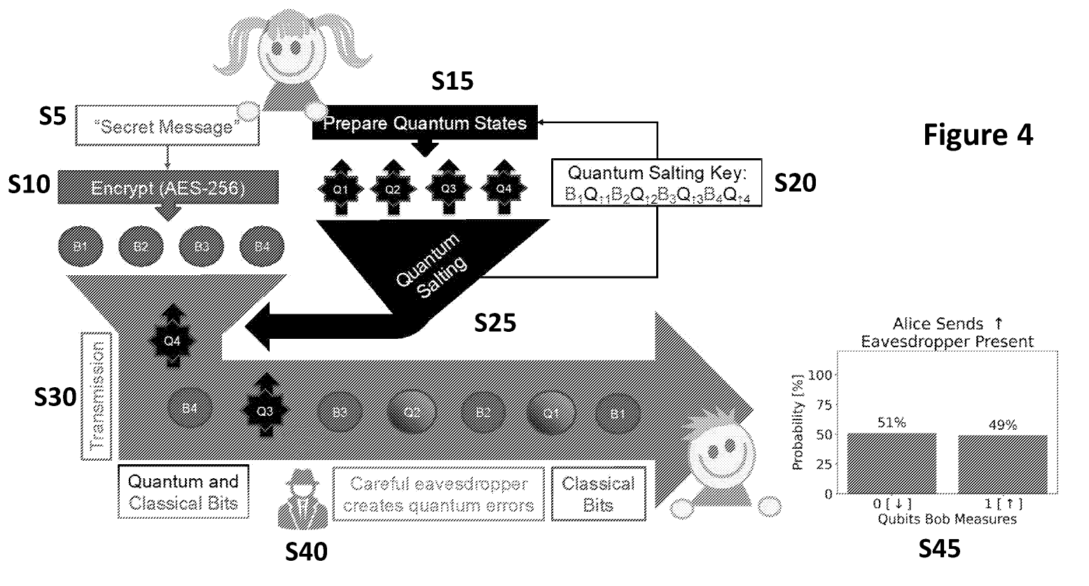

Referring to FIG. 4, in this example, the classical bit data message is encrypted with AES-256 encryption and an eavesdropper creates quantum errors in the qubit augmented message during transmission S40. Using the quantum salting key, the receiver is able to ascertain the presence of the eavesdropper S45.

With respect to determining if an eavesdropper is present, ff all bits arrive according to the salting key within tolerance of error due to the more fragile state of quantum bits, the line is clean (FIG. 2). Should an unusually high amount of the bits arrive in a different state, the receiver will know they have been detected prior to his reception, as any eavesdropping on the line will collapse the quantum states (FIG. 3). The change in qubit state due to eavesdropper detection along the line will only be known to the receiver at his end.

The known orientation of the salted bits does not decrease the effectiveness of this eavesdrop detection as this knowledge does not compromise Quanary or reduce its effectiveness. The key advantage to sending quantum bits is that they themselves do not contain any information if simply detected; the information is gained from the correlation of the state sent and the state received. Quanary is the first demonstration of a hybrid classical-quantum encrypted data stream, and the quantum nature of the salted bits is not apparent to the transmitter’s classical detection. Detecting the quantum photons immediately, unavoidably alerts the receiver without the transmitter knowing. The decoy qubits contain no important information, leaving the eavesdropper with encrypted data with an extra layer or encryption that looks like random bits.

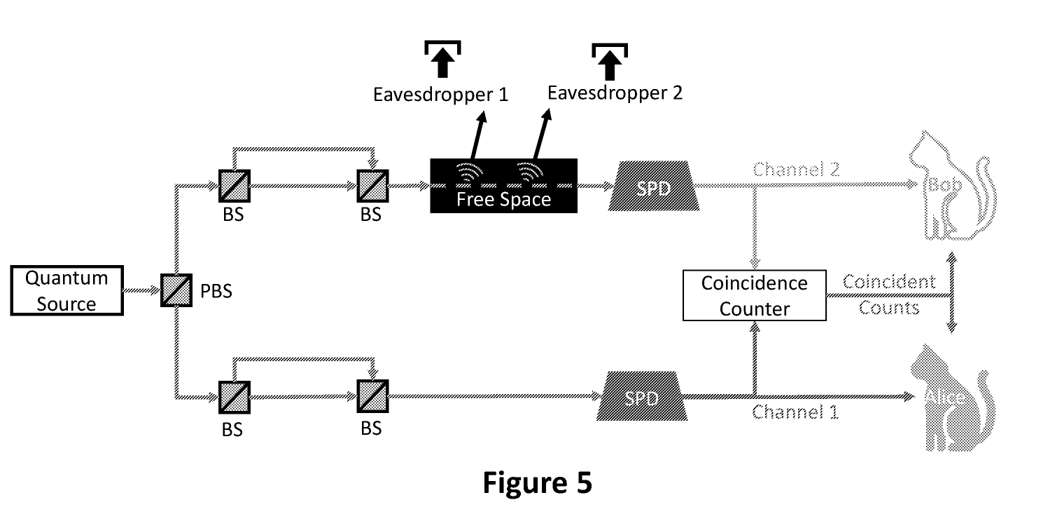

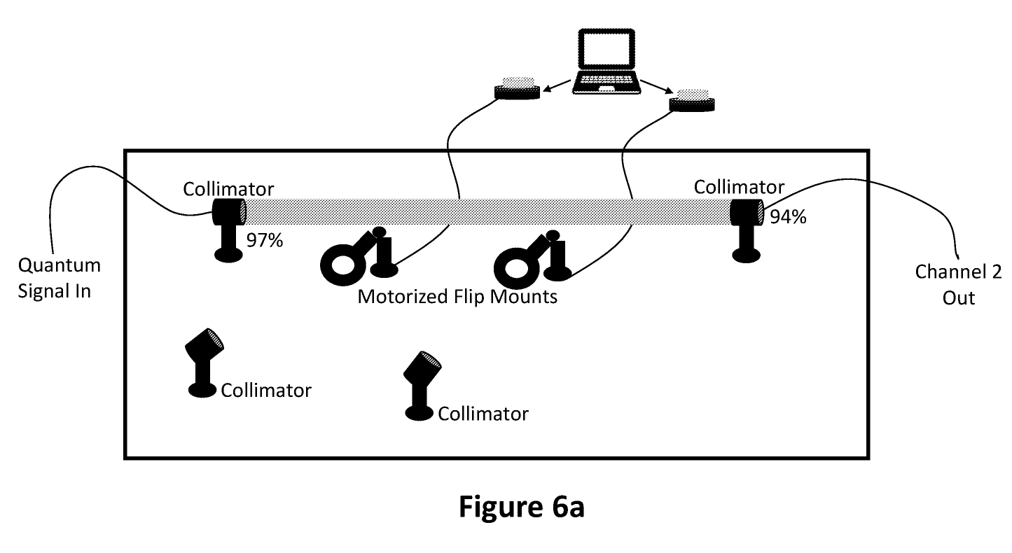

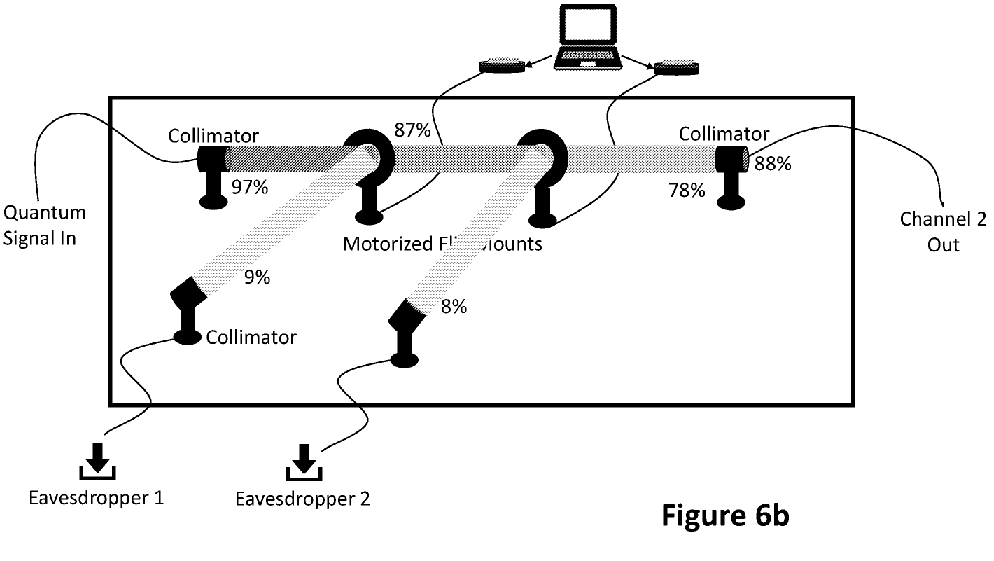

A critical feature of successful implementation of Quanary is the ability to detect an eavesdropper on the transmission line. The experimental set-up of FIG. 5 was used to prove detection is achievable. A quantum source generates entangled pairs, but to increase the rate and stability of our entanglement generation, we pass all photons emitted through an unbalanced Mach-Zender interferometer which generates time-bin entangled photons. These time-bin entangled photons are detected on our reference channel, Channel 1 (experimental sender/transmitter), and on our attack channel, Channel 2 (experimental receiver). We detect both raw counts on each channel and the coincident events between the two, which is a measurement of the entanglement that survives transmission to be detected. For the proof of concept of detecting eavesdroppers, we constructed a free-space optical dark box on Channel 2 and equipped it with two motorized flip mounts, as shown in FIGS. 6a and 6b. For robustness, we do not limit ourselves to a single attacker, but want to ensure our technique can detect multiple attacks on the same line. One skilled in the art will appreciate that an identical optical box can be set up on the sender’s line/Channel 1, to demonstrate feasibility of detection of multiple eavesdroppers on either line. The data output from the set-up of FIG. 5 includes Channel 1 data, Channel 2 data and coincidence data.

In accordance with FIG. 6b, at the push of a button (or computer control), the flips mounts move up and down into the optical beam and act as attackers by sampling the beam and diverting a few photons to a separate detector (collimator). This also enables us to observe what the eavesdroppers are detecting. For data collection and detection techniques, we do not want any determinable pattern to the attacks that can be learned or trained into our detection techniques. Therefore, both flip mounts are controlled by computer and they are triggered at random.

One skilled in the art will appreciate that optimal detection methods may be experimentally investigated and tested and may include, e.g., machine learning and statistical detection. By way of example, using Channel 1 and Channel 2 data generated using the system of FIG. 5, an attack algorithm was developed. As a starting point, the state of the art CUSUM-based attack detection approach proposed for QKD attack detection and described in Gong et al. was evaluated (Experimental demonstration of confidential communication with quantum security monitoring. Scientific Reports, 11(1), 1-16). In analyzing the CUSUM algorithm, it was determined that the algorithm can accurately predict the start of an attack, but when an attack is signaled, the running sum continues to collect. As the running sum continues to collect, the descent back to normal after an attack is too long, so cannot be used to indicate the end of an attack. This is problematic as understanding the end of attacks is important for determining who caused it and assessing the damage. Further, the kinds of attacks that Quanary would see are a continual attack instead of one-off bursts. This means that if we reset every time we see an attack, we would be incessantly signaling attacks even though it’s just a single attack with a defined start and end point.

First, a new algorithm was developed where we cap the running sum (“Cap running sum” algo) so that it does not continue to collect in an unbounded fashion. The effect of this is that the running sum triggers the CUSUM alarm as normal, but when the attack ends, it is a much shorter descent down to non-attack status. In other words, our approach proceeds as follows:
1. Keep a running sum of values above some fixed threshold
2. If the running sum is above an alarm threshold, signal an attack is occurring
3. Cap the running sum to some fixed value slightly above the attack threshold Applying this algorithm to the correlated jamming data from Gong et al which consists of 1000 sample points with a single attack that starts at point 100 and ends at point 300, the Cap running sum algo detected the attack at step 109 (~0.072 second delay) and detected attack ended at step 306 (~0.048 second delay). The Cap running sum algo accurately predicts start and end with little lag. But once we started producing data from our experimental set-up (FIG. 5), we quickly discovered that the Cap running sum algo approach would not be sufficient to detect attacks. The reason is that the data does not stabilize around a fixed value and has too many jumps to use a running mean. This means that a CUSUM-based approach like the Cap running sum algo would signal too many false positives to be effective.

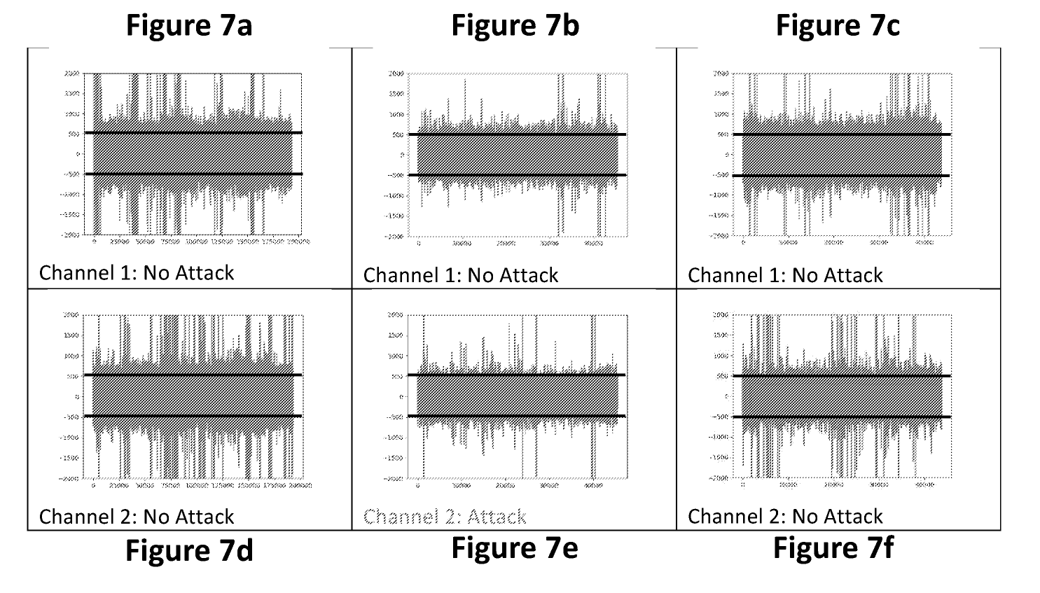

In order to mitigate this issue, we analyze the first differences of the data. The first difference is the change in counts between successive time steps, i.e., yₜ = xₜ - xₜ₋₁. Unlike with the raw channel data, we see that the first differences are much more stable, which allowed us to develop an attack detection method. To do this, we first notice that the non-attack data have much larger first differences than the attack data. For example, in FIGS. 7a, 7b, 7c, 7d, 7e, 7f, we see that the channels that are not being attacked have much larger first differences, but the channel that is being attacked has smaller first differences. The horizontal lines at 500 and -500 highlight the differences. FIGS. 7a, 7b, 7c, 7d, 7e, 7f represent Channel 1 and Channel 2 data from the October 28^{th} (FIGS. 7a, 7d), October 31^{st} (FIGS. 7b, 7e), and November 2^{nd} (FIGS. 7c, 7f) collections.

We transform these insights into an attack detection scheme where we count how often the first difference has a “large” value in the last N steps. Channels that are not being attacked consistently have “large” values whereas channels that are being attacked do not consistently have “large” values. More concretely, our attack detection scheme is as follows:
a. Look at 250 previous steps
   i. The last N steps
b. Count how many times the absolute value of the first difference is above 300
   i. 300 is our definition of “large”
c. If the count is below 34 then signal an attack
   i. 34 is the lowest count number across all 250 step windows in the channels that are not being attacked

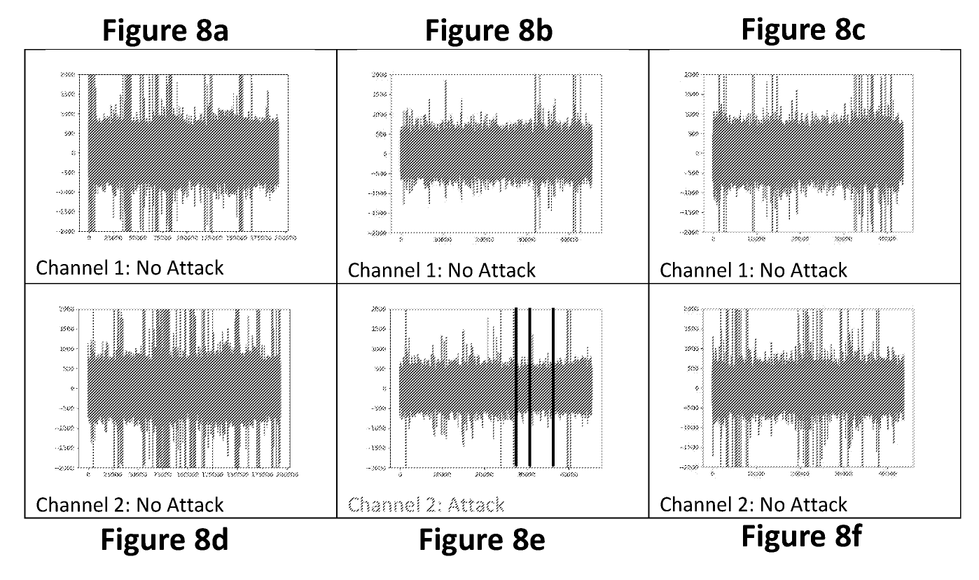

We evaluated this approach on the Channel 1 and Channel 2 data from October 28^{th}, October 31^{st}, and November 2^{nd}. The results of this approach are shown in FIGS. 8a, 8b, 8c, 8d, 8e, 8f. We see that the attacked channel (FIG. 8e) has detected alarms (vertical bars) while the channels that were not attacked lack any bars, i.e., no false positives. This confirms that our attack detection scheme can detect alarms with 100% precision.

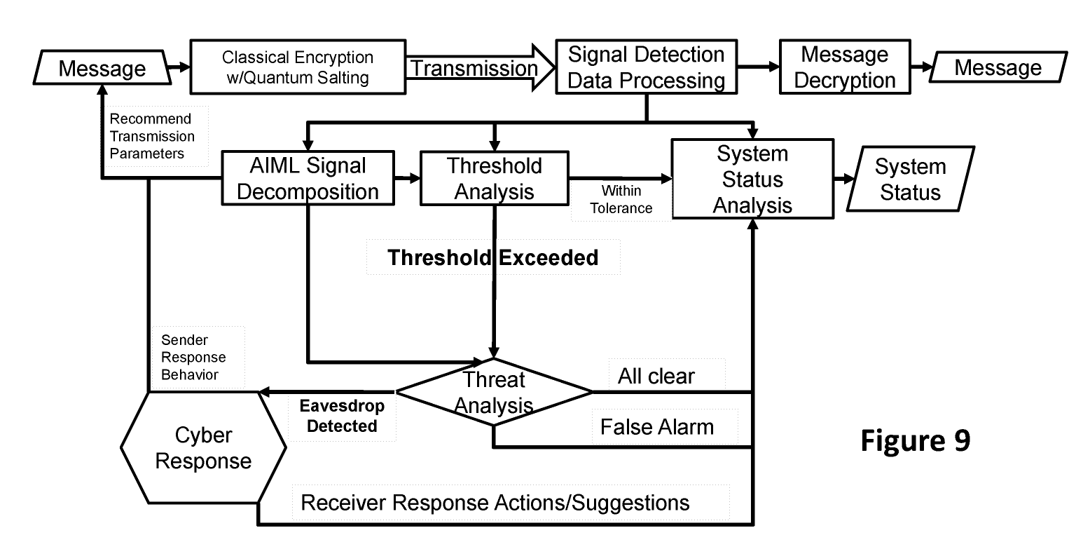

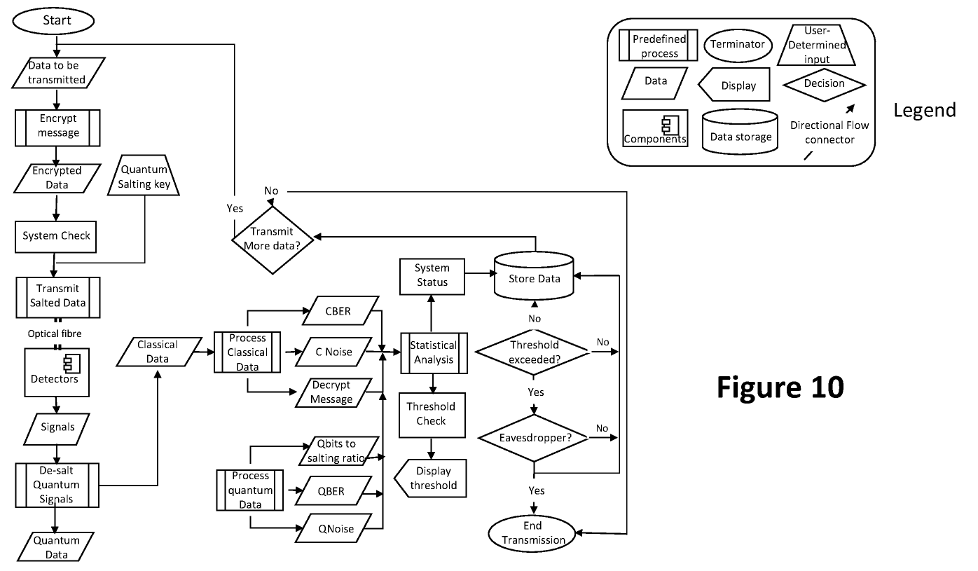

FIG. 9 provides a more detailed schematic of the implementation of the attack detection process. FIG. 10 provides a more detailed schematic of the attack detection system in accordance with the embodiments herein.

A more detailed example of a hybrid classical-quantum encrypted data stream referenced above is described below. Initially, a quantum salting key determining the placement of the transmission’s decoy qubits amongst the classical bits is agreed upon between the sender (transmitter) and receiver. In an exemplary quantum salting key, or shared secret, 1 s represent classical data and 0 s represent quantum data. A quantum state is agreed upon for the qubits. Since the qubits are primarily used for eavesdropping detection, it doesn’t matter what the state is or how easy it is to guess. In this specific example, all the qubits Alice sends are 0 s and the quantum salting key between Alice and Bob is as follows:

Alice and Bob’s Shared Secret:: 101100101001011111000001010101000100010

Next, a message is generated and encrypted using classical methods, such as AES-256.

### EXAMPLE

Alice’s plaintext message: ‘Leidos intends to purchase Gibbs & Cox.’
Alice’s AES-encrypted message: b‘\xce]y\x99\x91\x92,\x8a\xf6\x92\x0b
\xab\xfb8>(D\x82\xdeJ[\xe29\x08\xf9\xb0Q\xbc\xc0\xe7Q\x07~
[\xde\xe3\xdb’.

Qubits are then prepared in the agreed-upon states, entangling photons via polarization or superposition, which is known to those skilled in the art. Note that the decoy qubits are added to the stream after standard encoding and are detected before decoding. This means that the qubits may be added to most standard block encryptions, with qubits inserted around blocks.

Following the agreed-upon salting key, the quantum bits (Q*) are interjected among the classical message’s bits (e.g., 206, 93, 121 et seq.) as the message is being sent/transmitted:

Alice sends her salted message to Bob: 206 Q* 931 121 Q* 153 Q* 145 1
46 44 Q* 138 246 Q* 146 11 171 Q* 251 56 Q* 62 Q* 40 Q* 68 Q* 130
Q* 222 74 91 146 226 57 Q* 8 249 Q* 176 81 Q* 188 192 Q* 29 231 81 7
Q* 126 91 222 227 Q* 219

Bob’s receiver detects the quantum states of the Q* to determine the presence of a potential eavesdropper. If all the Os sent by Alice arrive at Bob, then there is no eavesdropper, as shown:

NO EAVESDROPPING DETECTED!
Bob measured: { ‘0’ : 17} and Bob received the message: ‘Leidos intends to
purchase Gibbs & Cox.’.

However, an eavesdropper’s detection of the qubits collapses them to classical states, which will be randomly distributed as Os and 1 s. If the eavesdropper disturbs all the qubits. Bob will receive a random distribution of 1 s and 0 s. If the eavesdropper does not disturb all qubits, there will be more of the original qubits, but disturbance will still be detectable, as shown:

WARNING: EAVESDROPPING DETECTED!
Bob measured: {‘1’ : 4, ‘0’ : 15} and Bob received the message: ‘Leidos
intends to purchase Gibbs & Cox.’.

As mentioned previously, noisy environments create interactions with data which can also collapse quantum systems, so there are known, industry-standard analysis methods used in the detection to ensure the detected eavesdropper is real and not background noise: e.g., quality of photon generation, error correction and metrology may be used to ensure that our data and our measurement methods are accurate enough to detect the eavesdropper.

While the specific embodiments described above implement entanglement, the application of Quanary is modular and extensible to other types of quantum properties, such as superposition. Superposition is a quantum effect for systems that can be in any number of combinations; those systems are most probably in a state-combination of all possible states. This creates inter-state dependence, similar to entanglement, and experiments have shown that superposition is another viable quantum property for communication use.

The flexibility of Quanary extends to the type of quantum information used for communications; as quantum communications works with either continuous variable (CV) quantum information or discrete variable (DV) quantum information. Continuous variable entanglement applies to such systems as those with inherently equidistant energy levels. Examples include atomic ensembles, or the amplitude of a quantum optical wave or light beams. In these cases, information is stored in continuous variables such as position, momentum, phase, and amplitude. Examples of discrete systems include atoms, quantum dots, and photons; any system with two distinct states such as the polarization of a photon or the energy levels of an atom. Any two energy levels or polarizations can then be chosen to represent a classical bit. Quantum communications has been experimentally proven with both DV and CV. While previous work with DV information was constrained by the difficulty of single photon generation, recent studies have mitigated much of the earlier concerns with this modality, allowing Quanary to integrate more discretely classical data, making it indistinguishable from the classical data for most eavesdroppers. For different use cases, Quanary’s modularity easily allows us to employ CV communications as well.

As quantum systems stabilize, more unique opportunities for communications will arise, and Quanary is designed to be extensible. Quanary’s modularity allows it to be agnostic to the method of encryption and transmission used and enables an agile response to the rapidly changing and developing fields of quantum communications and computing, and cryptography.

The following documents are evidence of the state of the prior art and would be known to one having ordinary skill in the art. The documents are incorporated herein by reference for their teachings:
Pirandola, Stefano, et al. “Advances in quantum cryptography.” Advances in Optics and Photonics 12.4 (2020): 1012-1236.
Lu, Hua, et al. “Unconditional security proof of a deterministic quantum key distribution with a two-way quantum channel.” Physical Review A 84.4 (2011): 042344.
Minder, M., et al. “Experimental quantum key distribution beyond the repeaterless secret key capacity.” Nature Photonics 13.5 (2019): 334-338.
Di Giuseppe, Giovanni, Francesco De Martini, and Danilo Boschi. “Experimental test of the violation of local realism in quantum mechanics without Bell inequalities.” Physical Review A 56.1 (1997): 176.
Lima, Gustavo, et al. “Experimental Bell-inequality violation without the postselection loophole.” Physical Review A 81.4 (2010): 040101.
Hosseinidehaj, Nedasadat, et al. “Satellite-based continuous-variable quantum communications: State-of-the-art and a predictive outlook.” IEEE Communications Surveys & Tutorials 21.1 (2018): 881-919.
Wang, Shuang, et al. “Proof-of-principle experimental realization of a qubit-like qudit-based quantum key distribution scheme.” Quantum Science and Technology 3.2 (2018): 025006.
Li, Ya-Ping, et al. “Experimental realization of a reference-frame-independent decoy BB84 quantum key distribution based on Sagnac interferometer.” Optics letters 44.18 (2019): 4523-4526.
Takesue, Hiroki, et al. “Experimental quantum key distribution without monitoring signal disturbance.” Nature Photonics 9.12 (2015): 827.
Zhao, Yi, et al. “Quantum hacking: Experimental demonstration of time-shift attack against practical quantum-key-distribution systems.” Physical Review A 78.4 (2008): 042333.
Pang, Xiao-Ling, et al. “Hacking quantum key distribution via injection locking.” Physical Review Applied 13.3 (2020): 034008.
Lee, Min Soo, et al. “Quantum hacking on a free-space quantum key distribution system without measuring quantum signals.” JOSA B 36.3 (2019): B77-B82.
Zhu, Feng, et al. “Experimental long-distance quantum secure direct communication.” Science Bulletin 62.22 (2017): 1519-1524.
Shi, Yu, and Edo Waks. “Deterministic generation of multi-dimensional photonic cluster states using time-delay feedback.” arXiv preprint arXiv:2101.07772 (2021).
Bracht, Thomas K., et al. “Swing-up of quantum emitter population using detuned pulses.” arXiv preprint arXiv:2111.10236 (2021).
Aoki, Takao, et al. “Quantum error correction beyond qubits.” Nature Physics 5.8 (2009): 541-546.
Kohlrus, Jan, et al. “Quantum communications and quantum metrology in the spacetime of a rotating planet.” EPJ quantum technology 4.1 (2017): 1-13.
Usuki, T., et al. “Single-photon generator for optical telecommunication wavelength.” Journal of Physics: Conference Series. Vol. 38. No. 1. IOP Publishing, 2006.
Yuan, Renzhi, and Julian Cheng. “Free-space optical quantum communications in turbulent channels with receiver diversity.” IEEE Transactions on Communications 68.9 (2020): 5706-5717.
Gong, Y., Wonfor, A., Hunt, J. H., White, I. H., & Penty, R. V. (2021). Experimental demonstration of confidential communication with quantum security monitoring. Scientific Reports, 11(1), 1- 16,

The embodiments described and claimed herein are not to be limited in scope by the specific examples herein disclosed since these examples are intended as illustrations of several aspects of the embodiments. Any equivalent examples are intended to be within the scope of the embodiments. Indeed, various modifications of the embodiments in addition to those shown and described herein will become apparent to those skilled in the art from the foregoing description. Such modifications are also intended to fall within the scope of the appended claims. All references including patents, patent applications and publications cited herein are incorporated herein by reference in their entirety and for all purposes to the same extent as if each individual publication or patent or patent application was specifically and individually indicated to be incorporated by reference in its entirety for all purposes.

1. A secure communication system comprising:
an optical transmitter;
a single photon emitter;
a photonic transmission line; wherein the optical transmitter prepares a classical data bit message and the single photon emitter prepares quantum bits in a predetermined orientation and salts the classical data bit message with the prepared quantum bits in accordance with a predetermined pattern resulting in a quantum augmented classical data bit message which is transmitted over the photonic transmission line.

2. The secure communication system of claim 1, further comprising
a dual quantum bit and classical bit receiver for receiving the transmitted quantum augmented classical data bit message and determining if the quantum augmented classical data bit message was intercepted by an eavesdropper during transmission.

3. The secure communication system of claim 1, wherein the optical transmitter encrypts the classical data bit message prior to the classical data bit message being salted with quantum bits.

4. A process for securing a classical data bit message, comprising:
generating a classical data bit message and encrypting the classical data bit message,
preparing quantum bits in a predetermined orientation;
salting the encrypted classical data bit message with the prepared quantum bits in accordance with a predetermined salting pattern resulting in a quantum augmented classical data bit message;
transmitting the quantum augmented classical data bit message over a photonic transmission line;
receiving the transmitted quantum augmented classical data bit message at a dual quantum bit and classical bit receiver; and
processing the quantum augmented classical data bit message to
i. determine if the quantum augmented classical data bit message was intercepted by an eavesdropper during transmission; and
ii. decode the quantum augmented classical data bit message to ascertain the message.

5. The process of claim 4, further comprising:
transmitting a first key which includes the predetermined salting pattern; and
transmitted a second key for decrypting the encrypted classical data bit message, wherein the first key and second key are transmitted over the photonic transmission line.
